(19) United States
(12) Patent Application Publication
(10) Pub. No.: US 2013/0120312 A1
(43) Pub. Date: May 16, 2013

(54) TOUCH PANEL

(71) Applicant: Japan Display East Inc., Mobara-shi (JP)

(72) Inventors: Keiichiro TAKAHASHI, Mobara (JP); Yasuyuki MISHIMA, Mobara (JP)

(73) Assignee: JAPAN DISPLAY EAST INC., Mobara-shi (JP)

(21) Appl. No.: 13/670,491

(22) Filed: Nov. 7, 2012

(30) Foreign Application Priority Data
Nov. 14, 2011 (JP) 2011-248860

(51) Int. Cl. G06F 3/045

(52) U.S. Cl. 345/174

(57) ABSTRACT

The present invention suppresses, without increasing manufacturing costs, diffusion of a conductive member forming wires and migration caused thereby. A touch panel includes a plurality of X electrode wires respectively connected to a plurality of X electrodes formed on a substrate, a plurality of Y electrode wires respectively connected to a plurality of Y electrodes formed on the substrate, and shield wires provided, at one end of the substrate, between a region where the plurality of X electrode wires are formed and a region where the plurality of Y electrode wires are formed. A pulse voltage changing between a GND voltage and a Va voltage higher than the GND voltage is supplied to respective wires of one of the X electrode wires and the Y electrode wires. A (Va/2) voltage is supplied to the shield wires in a period in which detection of a touch position is performed.

### CROSS-REFERENCE TO RELATED APPLICATION

The present application claims priority from Japanese application JP2011-248860 filed on Nov. 14, 2011, the content of which is hereby incorporated by reference into this application.

### BACKGROUND OF THE INVENTION

1. Field of the Invention

The present invention relates to a touch panel and, more particularly, to a technique effective in suppressing occurrence of migration of a conductive member (e.g., silver) forming an electrode wire.

2. Description of the Related Art

As main type of a touch panel, a type for detecting a change in light and a type for detecting a change in an electric characteristic are known. As the type for detecting a change in an electric characteristic, a capacitance coupling type is known.

As a touch panel of the capacitance coupling type in the past, a touch panel including a plurality of X electrodes and a plurality of Y electrodes crossing the X electrodes is known. In the touch panel of the capacitance coupling type publicly known in the past, the Y electrode is formed by an electrode pattern in which a plurality of crossing sections and a plurality of electrode sections wider than the width of the crossing sections are alternately arranged. The X electrode is formed by an electrode pattern in which a plurality of crossing sections and a plurality of electrode sections wider than the crossing sections are alternately arranged. The X electrodes and the Y electrodes are formed of a material having high transparency, for example, a transparent conductive material such as an ITO (Indium Tin Oxide).

In the capacitance-coupling touch panel in the past, migration of silver forming X electrode wires and Y electrode wires formed on a substrate (e.g., a glass substrate) occurs. As a result, an operation failure of the touch panel is caused. Therefore, a technique for suppressing the occurrence of the migration of silver is disclosed in JP 2005-251692 A.

### SUMMARY OF THE INVENTION

In JP 2005-251692 A, a diffusion preventing film (a carbon film) is provided to cover a bottom surface, a side surface, and a top surface of the wires formed of silver to prevent the occurrence of the migration of silver. However, in the technique described in JP 2005-251692 A, the wires need to be covered with the carbon film functioning as the diffusion preventing film. Therefore, manufacturing costs increase.

The present invention has been devised in order to solve the problems of the related art. It is an object of the present invention to provide a technique for making it possible to suppress, without increasing manufacturing costs, diffusion of a conductive member forming wires and migration in a touch panel caused thereby.

The above-mentioned object and other objects and new characteristics of the present invention are made apparent by the description of this specification and the accompanying drawings.

Overviews of representative inventions among inventions disclosed in this application are briefly explained below.

(1) A touch panel including a substrate, a plurality of X electrodes formed on the substrate, a plurality of Y electrodes formed on the substrate to respectively cross the plurality of X electrodes, a plurality of X electrode wires formed on the substrate and respectively connected to the plurality of X electrodes, and a plurality of Y electrode wires formed on the substrate and respectively connected to the plurality of Y electrodes. The touch panel includes, on arbitrary one side of the substrate, shield wires provided between a region where the plurality of X electrode wires are formed and a region where the plurality of Y electrode wires are formed. A pulse voltage changing between a GND voltage and a Va voltage higher than the GND voltage is supplied to respective wires of one of the X electrode wires and the Y electrode wires. An arbitrary voltage (e.g., a (Va/2) voltage) between the GND voltage and the Va voltage is supplied to respective wires of the other of the X electrode wires and the Y electrode wires and the shield wires in a period in which detection of a touch position is performed.

(2) A touch panel including a substrate, a plurality of X electrodes formed on the substrate, a plurality of Y electrodes formed on the substrate to respectively cross the plurality of X electrodes, a plurality of X electrode wires formed on the substrate and respectively connected to the plurality of X electrodes, and a plurality of Y electrode wires formed on the substrate and respectively connected to the plurality of Y electrodes. The touch panel includes, on arbitrary one side of the substrate, shield wires provided between a region where the plurality of X electrode wires are formed and a region where the plurality of Y electrode wires are formed. A pulse voltage changing, around a GND voltage, between a (Va/2) voltage higher than the GND voltage and a (−Va/2) voltage lower than the GND voltage is supplied to respective wires of one of the X electrode wires and the Y electrode wires. The GND voltage is supplied to respective wires of the other of the X electrode wires and the Y electrode wires.

(3) A touch panel including a substrate, a plurality of X electrodes formed on the substrate, a plurality of Y electrodes formed on the substrate to respectively cross the plurality of X electrodes, a plurality of X electrode wires formed on the substrate and respectively connected to the plurality of X electrodes, and a plurality of Y electrode wires formed on the substrate and respectively connected to the plurality of Y electrodes. The touch panel includes loop wires formed on the outer sides of respective wires of one of the X electrode wires and the Y electrode wires. A pulse voltage changing between a GND voltage and a Va voltage higher than the GND voltage is supplied to respective wires of the other of the X electrode wires and the Y electrode wires. An arbitrary voltage (e.g., a (Va/2) voltage) between the GND voltage and the Va voltage is supplied to the respective wires of the one of the X electrode wires and the Y electrode wires and the loop wires in a period in which detection of a touch position is performed.

### EFFECT OF THE INVENTION

An effect obtained by the representative invention among the inventions disclosed in this application is as briefly explained below. With the touch panel according to the present invention, it is possible to suppress, without increasing manufacturing costs, diffusion of a conductive member forming wires and migration caused thereby.

### BRIEF DESCRIPTION OF THE DRAWINGS

FIG. 1 is a plan view showing an electrode pattern of a touch panel of a capacitance coupling type forming the premise of the present invention;

FIG. 2 is a sectional view showing a sectional structure taken along an II-II line shown in FIG. 1;

FIG. 3 is a sectional view showing a sectional structure taken along a line shown in FIG. 1;

FIG. 4 is a diagram for explaining a wiring pattern of the capacitance-coupling touch panel shown in FIG. 1;

FIGS. 5A to 5C are diagrams for explaining a driving method for the touch panel of the capacitance coupling type according to a first embodiment of the present invention;

FIGS. 6A and 6B are diagrams for explaining a driving method for a touch panel of a capacitance coupling type according to a second embodiment of the present invention;

FIGS. 7A and 7B are diagrams for explaining a driving method for a capacitance-coupling touch panel in the past;

FIG. 8 is a diagram for explaining a place where migration occurs in the capacitance-coupling touch panel in the past; and

FIG. 9 is a diagram for explaining a state in which migration occurs in the capacitance-coupling touch panel in the past.

### DETAILED DESCRIPTION OF THE INVENTION

Embodiments of the present invention are explained in detail below with reference to the accompanying drawings. In all the figures for explaining the embodiments, components having the same functions are denoted by the same reference numerals and signs and repeated explanation of the components is omitted. The embodiments explained below are not embodiments for limiting the interpretation of patent claims of the present invention.

### Overview of a Touch Panel of a Capacitance Coupling Type Forming the Premise of the Present Invention

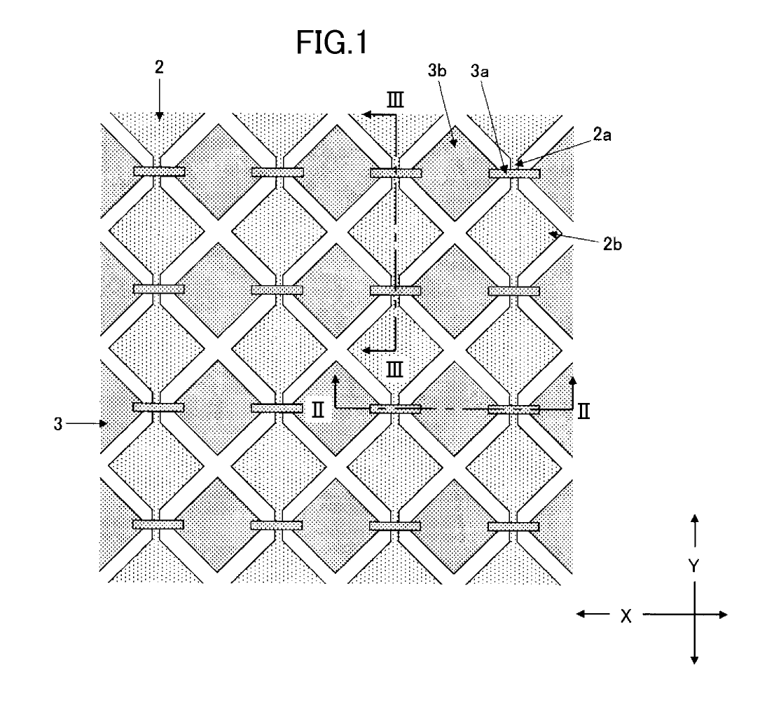

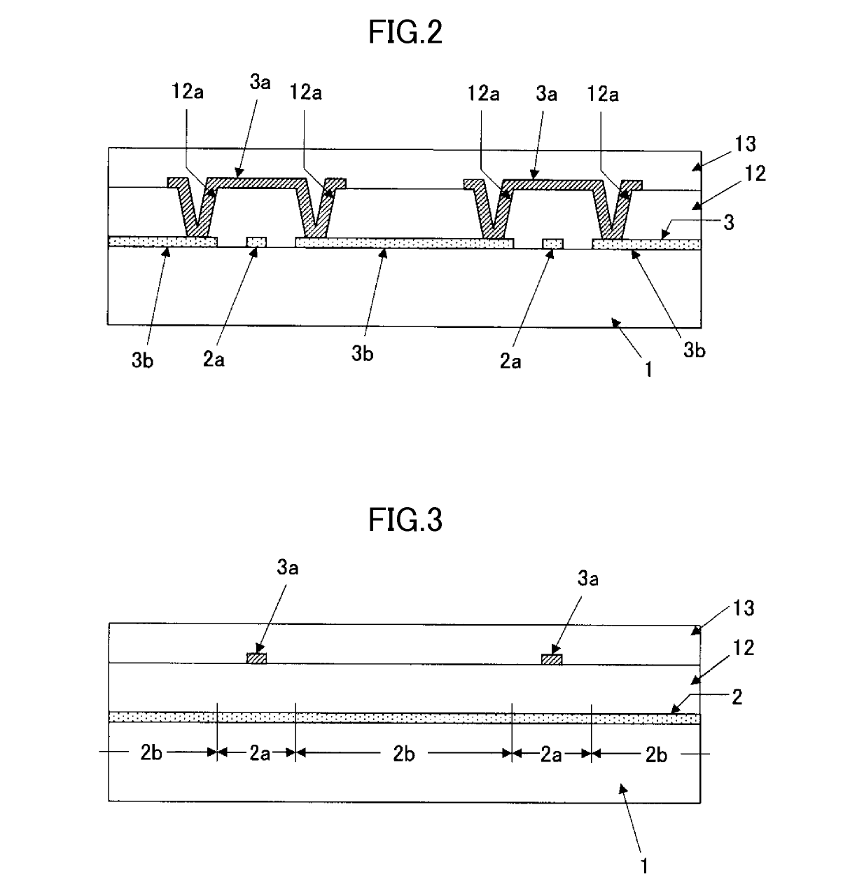

FIGS. 1 to 3 are diagrams for explaining a touch panel of a capacitance coupling type forming the premise of the present invention. FIG. 1 is a plan view showing an electrode pattern of the touch panel of the capacitance coupling type forming the premise of the present invention. FIG. 2 is a sectional view showing a sectional structure taken along an II-II line shown in FIG. 1. FIG. 3 is a sectional view showing a sectional structure taken along a line shown in FIG. 1. The touch panel of the capacitance coupling type shown in FIGS. 1 to 3 includes a plurality of X electrodes (hereinafter referred to as detection electrodes) 3 extending in a first direction (e.g., an X direction) and provided in parallel at a predetermined array pitch in a second direction (e.g., a Y direction) crossing the first direction, and a plurality of Y electrodes (hereinafter referred to as scanning electrodes 2) 2 extending in the second direction to cross the detection electrodes 3 and provided in parallel at a predetermined array pitch in the first direction.

Each of the plurality of scanning electrodes 2 is formed in an electrode pattern in which a plurality of crossing sections 2a and a plurality of electrode sections 2b wider than the crossing section 2a are alternately arranged in the second direction. Each of the plurality of scanning electrodes 2 is arranged on the upper surface of the substrate 1 and covered with an insulating film 12 formed in an upper layer of the substrate 1. As the substrate 1, a transparent insulative substrate of glass or the like is used.

Each of the plurality of detection electrodes 3 is formed in an electrode pattern in which a plurality of crossing sections 3a and a plurality of electrode sections 3b wider than the crossing sections 3a are alternately arranged in the first direction. The crossing sections 3a of each of the plurality of detection electrodes 3 are formed in a layer different from the scanning electrode 2 and planarly cross the crossing sections 2a of the scanning electrode 2. The electrode sections 3b of each of the plurality of detection electrodes 3 are formed in the same layer as the electrode sections 2b of the scanning electrode 2 and formed to be separated from the scanning electrode 2. The electrode sections 3b of the detection electrode 3 and the electrode sections 2b of the scanning electrode 2 are formed in a rhombus shape viewed from a direction orthogonal to the substrate 1.

The electrode sections 3b of each of the plurality of detection electrodes 3 are covered with the insulating film 12 in the same manner as the scanning electrodes 2. The crossing sections 3a of each of the plurality of detection electrodes 3 are arranged on the insulating film 12 and covered with a protection film 13 formed in an upper layer of the insulating film 12. The crossing sections 3a of the detection electrode 3 planarly cross the crossing sections 2a of the scanning electrode 2. The crossing section 3a is electrically and mechanically connected to, via a contact hole 12a formed in the insulating film 12 functioning as an interlayer insulating film formed between the crossing section 3a and the scanning electrode 2, two electrode sections 3b adjacent to each other across the crossing section 3a.

When viewed planarly, the electrode section 2b of the scanning electrode 2 is arranged between the crossing sections 3a of two detection electrodes 3 adjacent to each other. The electrode section 3b of the detection electrode 3 is arranged between the crossing sections 2a of two scanning electrodes 2 adjacent to each other. The detection electrode 3 and the scanning electrode 2 are formed of a material having high transparency, for example, a transparent conductive material such as an ITO (Indium Tin Oxide).

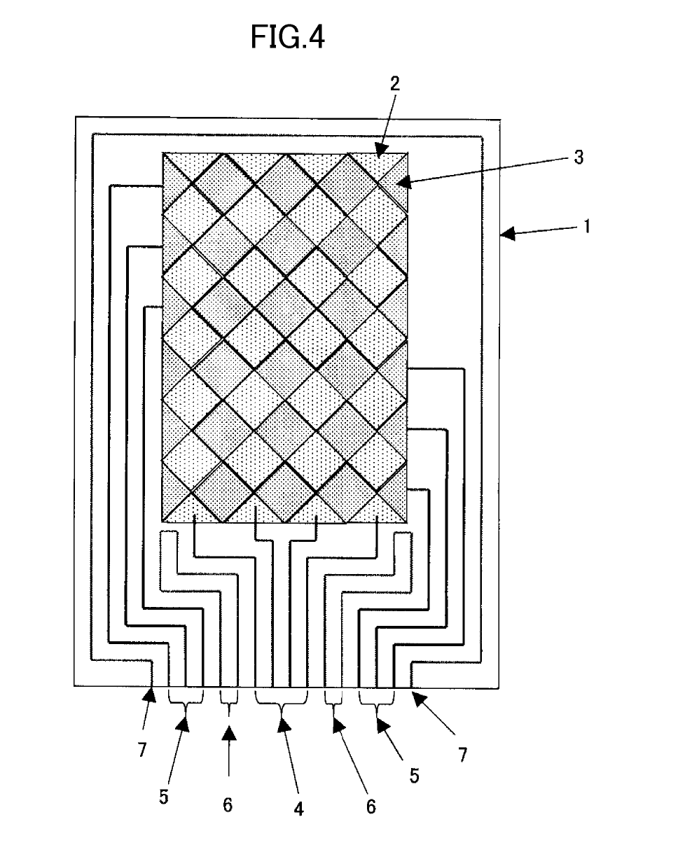

FIG. 4 is a diagram for explaining a wiring pattern of the capacitance-coupling touch panel shown in FIG. 1. In FIG. 4, reference numeral 4 denotes Y electrode wires (hereinafter referred to as scanning wires) for connecting the scanning electrodes 2 to a touch panel driving IC and 5 denotes X electrode wires (hereinafter referred to as detection wires) for connecting the detection electrodes 3 to the touch panel driving IC. The scanning wires 4 and the detection wires 5 are formed of metal layers of silver or the like.

Each of the scanning wires 4 is connected to an external terminal formed on an end on arbitrary one side of the substrate 1. Each of the detection wires 5 is connected to the external terminal formed on the end on the arbitrary one side of the substrate 1. Reference numeral 6 denotes shield wires for electrically separating the scanning wires 4 and the detection wires 5. The shield wires 6 are formed of a metal layer of silver or the like.

As shown in FIG. 4, on the arbitrary one side of the substrate 1, a plurality of detection wires 5 are formed in regions on the outer sides of a plurality of scanning wires 4. The shield wires 6 are formed between a region where the plurality of scanning wires 4 are formed and the regions where the plurality of detection wires 5 are formed.

Reference numeral 7 denotes loop wires formed on the outer sides of the detection wires 5. The loop wires 7 are provided in order to detect chips of a peripheral section of the substrate 1 in a touch panel manufacturing process. The shield wires 6 and the sloop wires 7 are also connected to the external terminal formed on the end on the arbitrary one side of the substrate 1.

### Problems of the Capacitance-Coupling Touch Panel in the Past

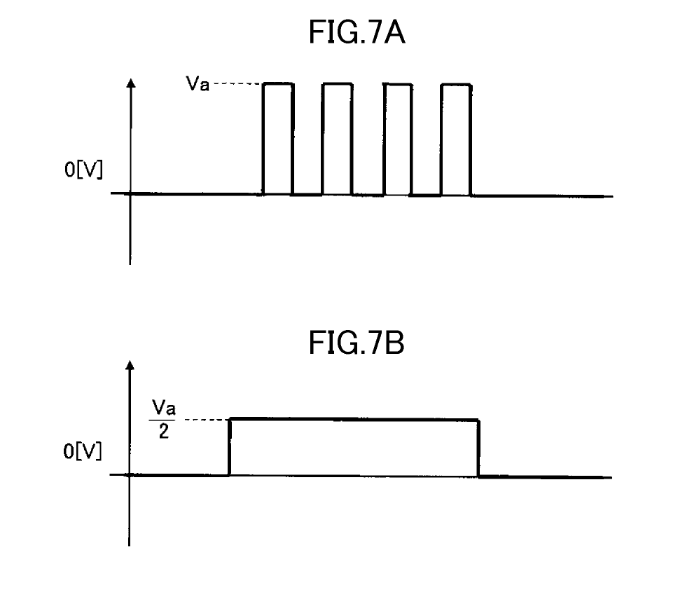

In a driving method for a touch panel in the past, a GND voltage is supplied to the shield wires 6 in order to electrically separate the scanning wires 4 and the detection wires 5. The GND voltage is supplied to the loop wires 7 during a touch panel operation, i.e., in a period in which detection of a touch position is performed. FIGS. 7A and 7B are diagrams for explaining the driving method for the touch panel of the capacitance coupling type in the past. FIG. 7A shows a voltage waveform of a driving voltage supplied to the scanning wires 4 in the driving method for the capacitance-coupling touch panel in the past. FIG. 7B shows a voltage waveform of a driving voltage supplied to the detection wires 5 in the driving method for the capacitance-coupling touch panel in the past.

As shown in FIG. 7A, a pulse voltage changing between the GND voltage and a Va voltage higher than the GND voltage is supplied to the scanning wires 4. With the pulse voltage, charging and discharging of capacitors formed at electrode intersections of the scanning electrodes 2 and the detection electrodes 3 shown in FIG. 1 are repeatedly performed. As shown in FIG. 7B, a (Va/2) voltage which is the center of the pulse voltage supplied to the scanning wires 4 is supplied to the detection wires 5 in the period in which the detection of a touch position is performed.

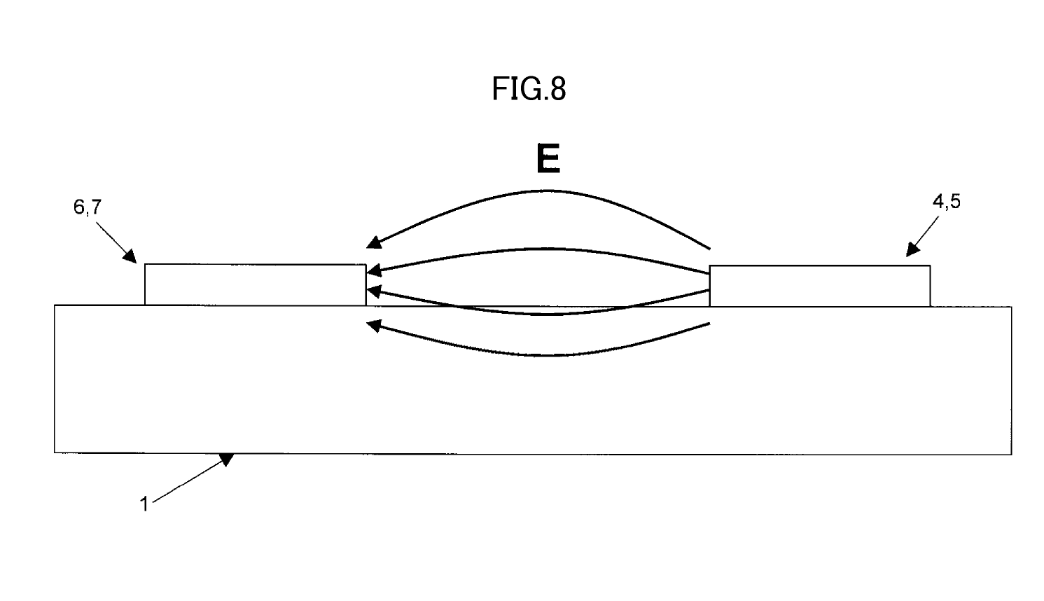

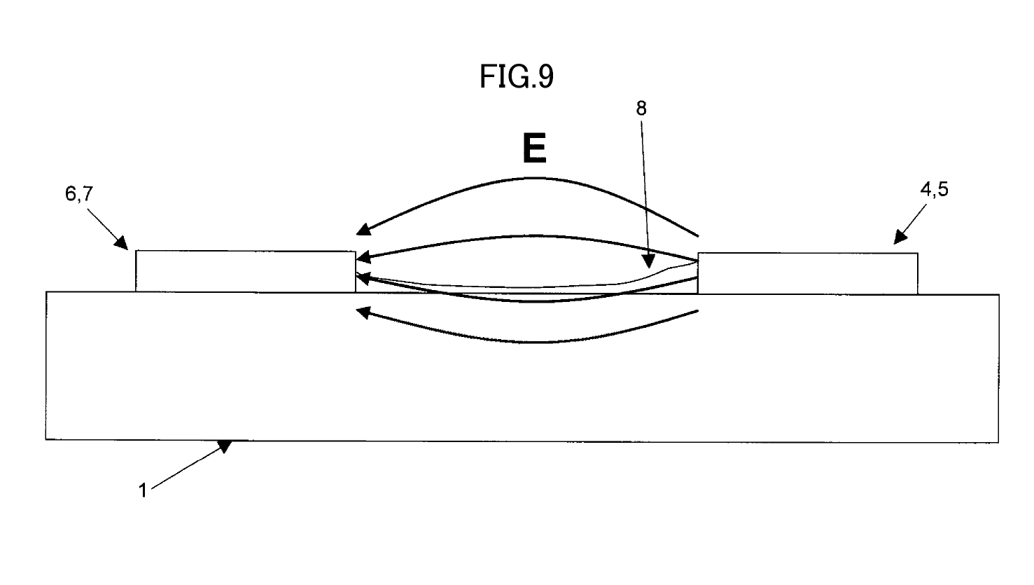

FIG. 8 is a diagram for explaining a place where migration occurs in the capacitance-coupling touch panel in the past. FIG. 9 is a diagram for explaining a state in which migration occurs in the capacitance-coupling touch panel in the past. FIGS. 8 and 9 are sectional views showing a sectional structure of the wiring section of the touch panel shown in FIG. 1. The place where migration occurs is present between the shield wires 6 and the loop wires 7 having the GND potential and the scanning wires 4 or the detection wires 5 adjacent to the shield wire 6 and the loop wire 7.

A space between the wires is equal to or smaller than about 30 μm. When the pulse voltage shown in FIGS. 7A and 7B is superimposed on the wires, an electric field from the scanning wires 4 to the direction of the shield wires 6 or an electric field from the detection wires 5 to the direction of the shield wires 6 and the loop wires 7 is generated. Therefore, when the touch panel is driven under a high humidity environment, ionized metal (silver) of the wires moves between the wires according to the electric field. As a result, as shown in FIG. 9, a short-circuit section 8 of the wires is caused. This is a mechanism of occurrence of migration of silver. The occurrence of migration causes an operation failure of the touch panel and deteriorates reliability of the touch panel.

In order to suppress the occurrence of migration, it is necessary to increase pitches of the wires (the scanning wires 4, the detection wires 5, the shield wires 6, and the loop wires 7) formed on the substrate 1. Therefore, in the driving method for the touch panel of the capacitance coupling type in the past, because the occurrence of migration is suppressed, the pitches of the wires formed on the substrate 1 cannot be reduced and a frame region in the peripheral section of the touch panel cannot be narrowed.

### First Embodiment

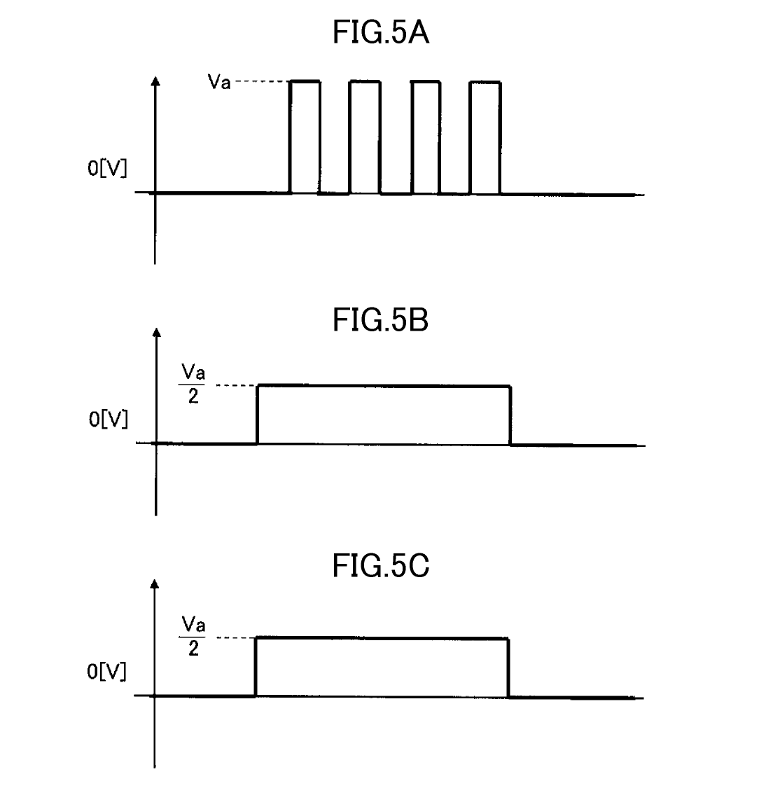

FIGS. 5A to 5C are diagrams for explaining a driving method for a touch panel of the capacitance coupling type according to a first embodiment of the present invention. FIG. 5A shows a voltage waveform of a driving voltage supplied to the scanning wires 4 during driving of the touch panel. FIG. 5B shows a voltage waveform of a driving voltage supplied to the detection wires 5 during the driving of the touch panel. FIG. 5C shows a voltage waveform of a driving voltage supplied to the shield wires 6 and the loop wires 7 during the driving of the touch panel.

In this embodiment, the voltages supplied to the scanning wires 4 and the detection wires 5 in the period in which the detection of a touch position is performed are the same as the voltages shown in FIGS. 7A and 7B. However, a voltage having the same waveform as the waveform of the voltage supplied to the detection wires 5 is supplied to the shield wires 6 and the loop wires 7 in the period in which the detection of a touch position is performed. Therefore, in this embodiment, a potential difference of a direct-current component between the scanning wires 4 and the shield wires 6 can be reduced to “0 V”. Therefore, field intensity of the direct-current component between the scanning wires 4 and the shield wires 6 can be reduced to “0” and field intensity between the detection wires 5 and the shield wires 6 and field intensity between the detection wires 5 and the loop wires 7 can also be reduced to “0”. Therefore, it is possible to suppress occurrence of migration.

As explained above, with the driving method according to this embodiment, it is possible to suppress occurrence of migration without providing the diffusion preventing film as described in JP 2005-251692 A. It is possible to improve reliability of the touch panel (in particular, reliability under a high humidity environment). Moreover, it is possible to expect a reduction in the pitches of the wires (the scanning wires 4, the detection wires 5, the shield wires 6, and the loop wires 7) formed on the substrate 1. Therefore, it is possible to provide a touch panel in which a frame region in the peripheral section of the touch panel is further narrowed.

In the above explanation, the voltage having the same waveform as the waveform of the voltage supplied to the detection wires 5 is supplied to the shield wires 6 and the loop wires 7 in the period in which the detection of a touch position is performed. However, the voltage supplied to the detection wires 5 or the voltage supplied to the shield wires 6 and the loop wires 7 may be an arbitrary voltage between the GND voltage and the Va voltage.

In this embodiment, the voltage having the same waveform as the waveform of the voltage supplied to the detection wires 5 may be supplied to only the loop wire 7 in the period in which the detection of a touch position is performed. In this case, the field intensity between the detection wires 5 and the loop wires 7 can be reduced to “0”. Therefore, it is possible to suppress occurrence of migration.

Further, in this embodiment, the scanning electrodes 2 may be provided in parallel at a predetermined array pitch in a second direction (e.g., a Y direction) crossing a first direction (e.g., an X direction) while being extended in the first direction, the detection electrodes 3 may be provided in parallel at a predetermined array pitch in the first direction while being extended in the second direction to cross the scanning electrodes 2, the scanning wires 4 may be formed in regions on the outer sides of the detection wires 5, and the loop wires 7 may be formed on the outer sides of the scanning wires 4.

### Second Embodiment

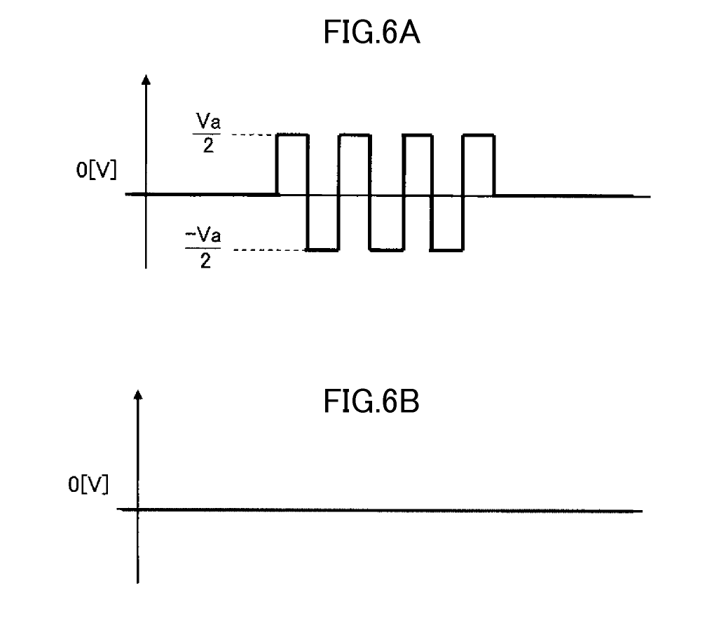

FIGS. 6A and 6B are diagrams for explaining a driving method for a touch panel of the capacitance coupling type according to a second embodiment of the present invention. FIG. 6A shows a voltage waveform of a driving voltage supplied to the scanning wires 4 during driving of the touch panel. FIG. 6B shows a voltage waveform of a driving voltage supplied to the detection wires 5 during the driving of the touch panel.

In this embodiment, a GND voltage is supplied to the shield wires 6. The GND voltage is supplied to the loop wires 7 in a period in which detection of a touch position is performed. In this embodiment, as shown in FIG. 6A, a pulse voltage changing, around the GND voltage, between a (Va/2) voltage and a (—Va/2) voltage is supplied to the scanning wires 4 in the period in which the detection of a touch position is performed. The GND voltage is supplied to the detection wires 5 in the period in which the detection of a touch position is performed.

Therefore, in this embodiment, a potential difference of a direct-current component between the scanning wires 4 and the shield wires 6 can be reduced to “0 V”. As a result, field intensity of the direct-current component between the scanning wires 4 and the shield wires 6 can be reduced to “0” and field intensity between the detection wires 5 and the shield wires 6 and field intensity between the detection wires 5 and the loop wires 7 can also be reduced to “0”. Therefore, it is possible to suppress occurrence of migration.

Consequently, with the driving method according to this embodiment, it is possible to obtain the same action and effects as those in the first embodiment. In this embodiment, it is necessary to use positive and negative power supplies for a touch panel driving IC. The reasons for this are, first, to supply a pulse voltage having negative potential shown in FIG. 6A to the scanning wires 4 and, second, to continuously apply the pulse voltage to the scanning electrodes 2 to thereby detect positive and negative electric currents during charging and discharging of capacitors formed at intersections of the scanning electrodes 2 and the detection electrodes 3.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A touch panel comprising:
a substrate;
a plurality of X electrodes formed on the substrate;
a plurality of Y electrodes formed on the substrate to respectively cross the plurality of X electrodes;
a plurality of X electrode wires formed on the substrate and respectively connected to the plurality of X electrodes; and
a plurality of Y electrode wires formed on the substrate and respectively connected to the plurality of Y electrodes,
the touch panel including, on arbitrary one side of the substrate, shield wires provided between a region where the plurality of X electrode wires are formed and a region where the plurality of Y electrode wires are formed, wherein
a pulse voltage changing between a GND voltage and a Va voltage higher than the GND voltage is supplied to respective wires of one of the X electrode wires and the Y electrode wires, and
an arbitrary voltage between the GND voltage and the Va voltage is supplied to the shield wires in a period in which detection of a touch position is performed.

2. The touch panel according to claim 1, wherein a (Va/2) voltage is supplied to the shield wires in the period in which the detection of a touch position is performed.

3. The touch panel according to claim 1, wherein an arbitrary voltage between the GND voltage and the Va voltage is supplied to respective wires of the other of the X electrode wires and the Y electrode wires in the period in which the detection of a touch position is performed.

4. The touch panel according to claim 3, wherein a (Va/2) voltage is supplied to the respective wires of the other of the X electrode wires and the Y electrode wires and the shield wires in the period in which the detection of a touch position is performed.

5. A touch panel comprising:
a substrate;
a plurality of X electrodes formed on the substrate;
a plurality of Y electrodes formed on the substrate to respectively cross the plurality of X electrodes;
a plurality of X electrode wires formed on the substrate and respectively connected to the plurality of X electrodes; and
a plurality of Y electrode wires formed on the substrate and respectively connected to the plurality of Y electrodes,
the touch panel including, on arbitrary one side of the substrate, shield wires provided between a region where the plurality of X electrode wires are formed and a region where the plurality of Y electrode wires are formed, wherein
a pulse voltage changing, around a GND voltage, between a (Va/2) voltage higher than the GND voltage and a (−Va/2) voltage lower than the GND voltage is supplied to respective wires of one of the X electrode wires and the Y electrode wires, and
the GND voltage is supplied to the shield wires.

6. The touch panel according to claim 5, wherein the GND voltage is supplied to respective wires of the other of the X electrode wires and the Y electrode wires.

7. A touch panel comprising:
a substrate;
a plurality of X electrodes formed on the substrate;
a plurality of Y electrodes formed on the substrate to respectively cross the plurality of X electrodes;
a plurality of X electrode wires formed on the substrate and respectively connected to the plurality of X electrodes; and
a plurality of Y electrode wires formed on the substrate and respectively connected to the plurality of Y electrodes,
the touch panel including loop wires formed on outer sides of respective wires of one of the X electrode wires and the Y electrode wires, wherein
a pulse voltage changing between a GND voltage and a Va voltage higher than the GND voltage is supplied to respective wires of the other of the X electrode wires and the Y electrode wires, and
an arbitrary voltage between the GND voltage and the Va voltage is supplied to the respective wires of the one of the X electrode wires and the Y electrode wires and the loop wires in a period in which detection of a touch position is performed.

8. The touch panel according to claim 7, wherein a (Va/2) voltage is supplied to the respective wires of the one of the X electrode wires and the Y electrode wires and the loop wires in the period in which the detection of a touch position is performed.
